(19) United States
(12) Patent Application Publication
(10) Pub. No.: US 2010/0040376 A1
(43) Pub. Date: Feb. 18, 2010

(54) RECEIVER

(76) Inventor: Chun-Yi Lin, Taipei (TW)

Correspondence Address: BIRCH STEWART KOLASCH & BIRCH, PO BOX 747, FALLS CHURCH, VA, 22040-0747, US

(21) Appl. No.: 12/423,394

(22) Filed: Apr. 14, 2009

(30) Foreign Application Priority Data
Aug. 15, 2008 (TW) 097131306

(51) Int. Cl. H04B 10/06

(52) U.S. Cl. 398/106; 398/208

(57) ABSTRACT

A receiver for use with a remote controller is provided. The receiver includes a signal receiver and a signal enhancer. The signal receiver has a signal receiving end. The signal enhancer is disposed in front of the signal receiver corresponding to the signal receiving end. The signal enhancer is transparent to light and has a concave structure. The signal receiver receives a signal through the signal enhancer.

### BACKGROUND OF THE INVENTION

1. Field of the Invention

This invention generally relates to a receiver. More particularly, this invention relates to a receiver for use with a remote controller.

2. Description of the Prior Art

For the convenience of use, more and more electronic devices including displayer such as television, video output device such as DVD player, and audio output device such as hi-fi equipment are generally equipped with remote control function. With such a configuration, a user lying on a couch can operate these electronic devices simply by manipulating a remote control in hand. In other words, by pressing, switching, or inducting, etc., the user can use the remote control to transmit a control signal to a signal receiving module of the electronic device so as to operate the electronic device.

As shown in FIG. 1, a conventional receiver 10 includes a receiving part 30 and a conventional transparent part 70, which is generally a transparent flat plate for protecting the receiving pat 30 from contaminants. The receiving part 30 is disposed on the main body 61 of the electronic device 60. The conventional transparent part 70 is disposed on an opposite side of the receiving part 30 corresponding to the main body 61. A case 63 of the electronic device 60 covers the conventional transparent part 70. A signal transmitted from a remote control 400 is transmitted to the receiving part 30 through a hole 63a of the case 63 and the conventional transparent part 70. Because the conventional receiver 10 usually has limits on the transmitting distance and the receiving angle, the application of the conventional receiver 10 is accordingly limited. Therefore, it is desirable to improve the above conventional receiver.

### SUMMARY OF THE INVENTION

It is an object of the present invention to provide a receiver for use with a remote controller.

It is another object of the present invention to provide a receiver having an improved signal receiving effect.

In one embodiment, a receiver includes a signal receiver and a signal enhancer. The signal receiver has a signal receiving end. The signal enhancer is disposed in front of the signal receiver corresponding to the signal receiving end. The signal enhancer is transparent to light and has a concave structure. The signal receiver receives a signal through the signal enhancer.

The concave structure includes a flat surface and a concave surface respectively disposed on opposite sides of the signal enhancer. The concave surface is disposed on a side of the signal enhancer close to or away from the signal receiver. The concave surface preferably has a diameter is 1.2 to 5 times the depth of the concave surface.

In another embodiment, the concave structure includes a first concave surface and a second concave surface respectively disposed on opposite sides of the signal enhancer. The first concave surface and the second concave surface have a same geometry shape or different geometry shapes, wherein the shapes include a circle, a triangle, a square, a rectangle, or other polygon.

In yet another embodiment, the concave structure includes a concave surface and a convex surface respectively disposed on opposite sides of the signal enhancer. The concave surface is disposed on a side of the signal enhancer close to or away from the signal receiver.

The receiver further includes a support part disposed on a side of the signal receiver corresponding to the signal receiving end, wherein the signal enhancer is disposed on the support part.

### BRIEF DESCRIPTION OF THE DRAWINGS

FIG. 1 is a schematic view of a conventional receiver;

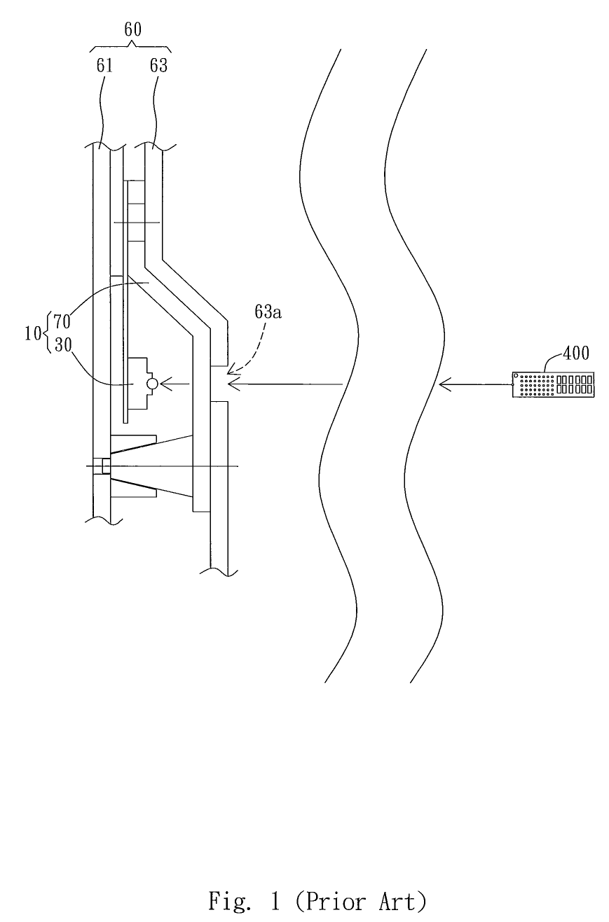

FIG. 2a is a perspective view of a receiver embedded into an electronic device for use with a remote control in accordance with a preferred embodiment of the present invention;

FIG. 2b is a schematic view of a receiver in accordance with a preferred embodiment of the present invention;

FIG. 2c is a schematic view showing the signal enhancement effect in accordance with one embodiment of the present invention;

FIG. 3a and FIG. 3b, are top and bottom perspective views of a signal enhancer in accordance with a preferred embodiment of the present invention;

FIG. 4a and FIG. 4b are top and bottom perspective views of a receiver in accordance with another embodiment of the present invention;

FIG. 5 shows a signal enhancer having a flat surface and a concave surface disposed on opposite sides, wherein the concave surface is recessed from the plane of a support part in accordance with one embodiment of the present invention;

FIG. 6 shows a signal enhancer having a flat surface and a concave surface disposed on opposite sides, wherein the concave surface is disposed away from a signal receiver in accordance with another embodiment of the present invention;

FIG. 7 shows a signal enhancer having two same concave surfaces disposed on opposite sides in accordance with another embodiment of the present invention;

FIG. 8 shows a signal enhancer having two different concave surfaces disposed on opposite sides in accordance with yet another embodiment of the present invention;

FIG. 9 shows a signal enhancer having a convex surface and a concave surface disposed on opposite sides, wherein the concave surface is disposed close to a signal receiver in accordance with another embodiment of the present invention; and

FIG. 10 shows a convex surface and a concave surface disposed on opposite sides, wherein the concave surface is disposed away from a signal receiver in accordance with another embodiment of the present invention.

### DETAILED DESCRIPTION OF THE PREFERRED EMBODIMENT

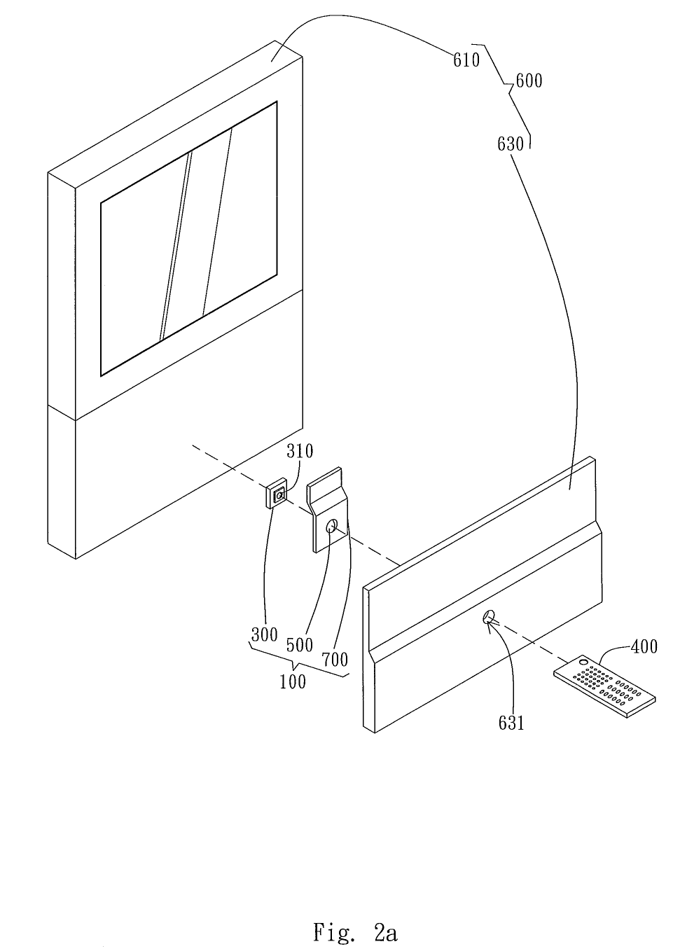

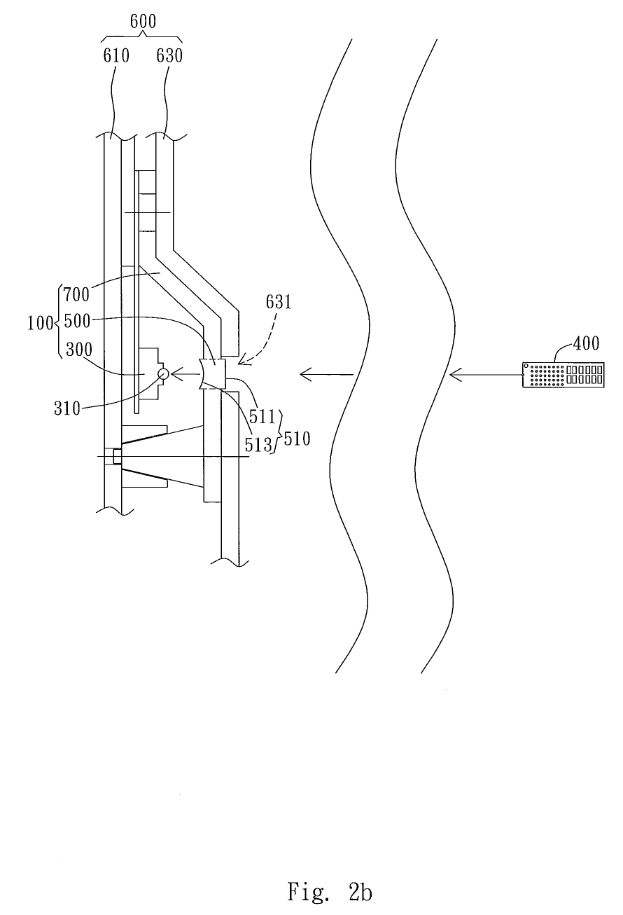

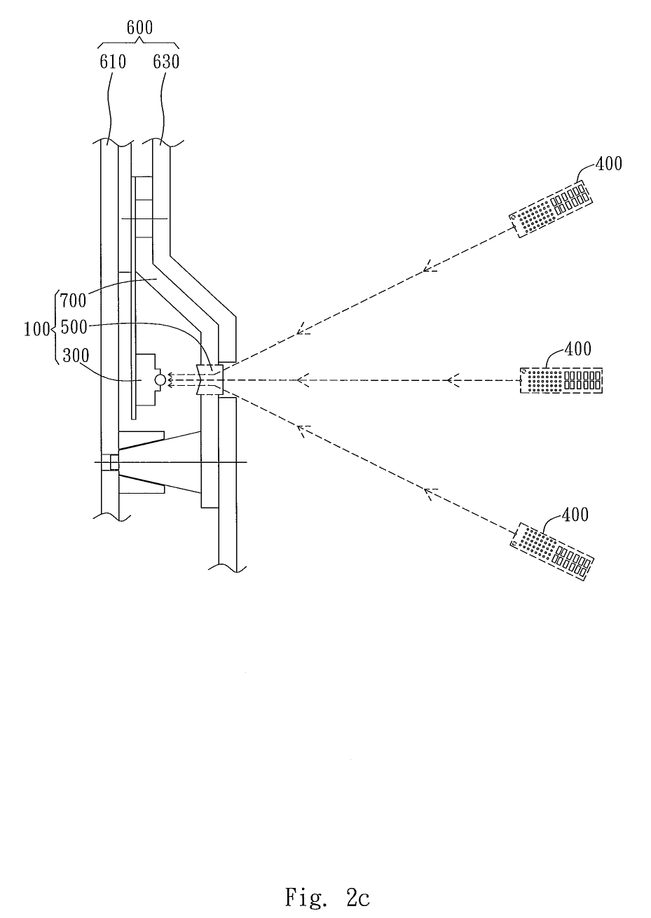

The present invention provides a receiver for use with a remote controller. In a preferred embodiment shown in FIG. 2a, the receiver 100 includes a signal receiver 300 and a signal enhancer 500. The remote controller 400 is a remote control of a displayer 600. The signal receiver 300 is disposed on the main body 610 of the displayer 600. The signal receiver 300 receives a signal transmitted from the remote controller 400 through the signal enhancer 500. In another embodiment, the receiver 100 can be an external peripheral device coupling with the displayer 600, instead of being integrated into the main body 610.

The receiver 100 further includes a support part 700 disposed on a same side of the signal receiver 300 corresponding to a signal receiving end 310 of the signal receiver 300. Furthermore, the displayer 600 includes a case 630 covering the support part 700. In other words, the support part 700 is disposed on an opposite side of the signal receiver 300 corresponding to the main body 610. The case 630 has a hole 631 corresponding to the signal enhancer 500. In other embodiments, however, the remote controller 400 may be a remote control of other electronic products, such as a video player, an audio player, and the likes.

The structure of the receiver 100 will now be described in greater detail. In a preferred embodiment shown in FIG. 2b, the signal receiver 300 has a signal receiving end 310. The signal enhancer 500 is disposed in front of the signal receiver 300 corresponding to the signal receiving end 310. The signal enhancer 500 is transparent to light and has a concave structure 510. In the preferred embodiment, the receiver 100 further includes a support part 700 disposed on a same side of the signal receiver 300 corresponding to the signal receiving end 310. The signal enhancer 500 is disposed on the support part 700, wherein the support part 700 is preferably bent to form a space to accommodate the signal receiver 300. Preferably, the support part 700 and the signal enhancer 500 are integrally formed into a single piece. In such a case, both of the support part 700 and the signal enhancer 500 are transparent to light. Alternatively, the support part 700 and the signal enhancer 500 can be independently formed and then assembled. When the support part 700 and the signal enhancer 500 are independently formed, the support part 700 is not necessarily transparent to light.

The signal receiver 300 receives a signal through the signal enhancer 500. Due to the concave structure 510, the signal enhancer 500 enhances the signal transmitted from the remote controller 400. More particularly, the signal enhancer 500 is a lens having the concave structure 510. That is, the signal enhancer 500 can be a concave lens, such as a plano-concave lens, a biconcave lens, or a convex-concave lens. In this embodiment, the signal enhancer 500 is a piano-concave lens. The signal enhancer 500 enhances the light by focusing lights or electric waves. In other words, the signal receiving effect of the signal receiver 300 can be improved by the signal enhancer 500. FIG. 2c is a schematic view showing the signal enhancement effect in accordance with one embodiment of the present invention.

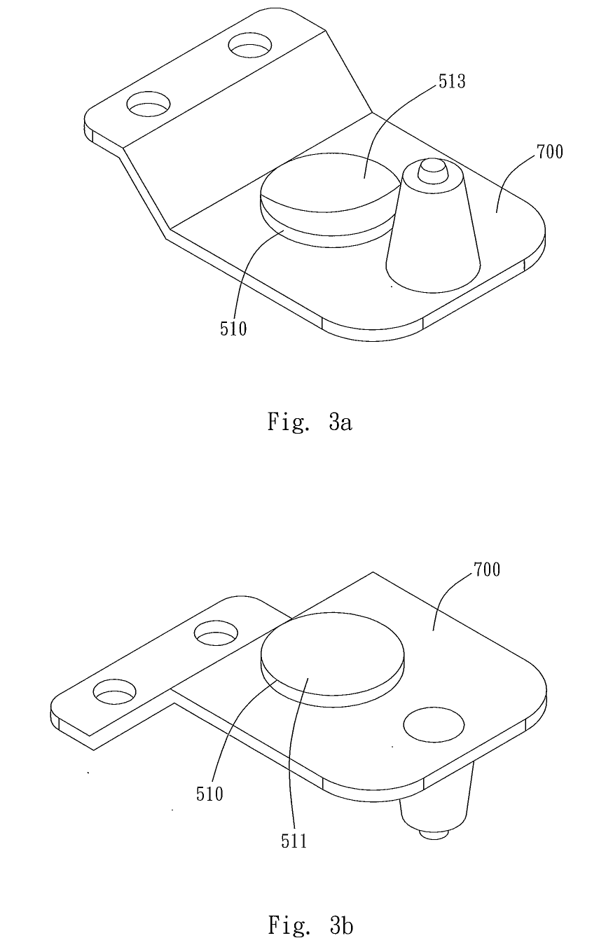

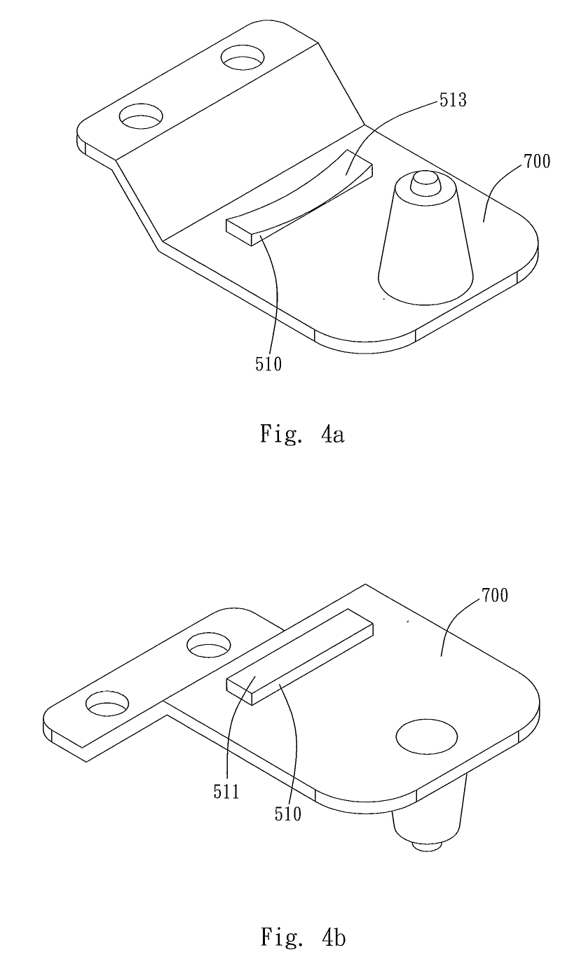

Details of the concave structure 510 of the signal enhancer 500 will now be described. As shown in FIG. 2b, the concave structure 510 includes a flat surface 511 and a concave surface 513 respectively disposed on opposite sides of the signal enhancer 500. The concave surface 513 having a diameter is 1.2 to 5 times a depth of the concave surface 513, and is preferably 2 times. The flat surface 511 and the concave surface 513 are disposed on two opposite sides of the signal enhancer 500. That is, the concave surface 513 is disposed on a side of the signal enhancer 500 close to the signal receiver 300, while the flat surface 511 is disposed on a side of the signal enhancer 500 away from the signal receiver 300. More particularly, the signal enhancer 500 is disposed to penetrate through the support part 700 with two blocks protruding out of the support part 700 on two opposite sides. That is, the flat surface 511 and the concave surface 513 are respectively formed on the two protruding blocks. FIG. 3a and FIG. 3b are bottom and top perspective views of the support part 700 combined with the signal enhancer 500 respectively. As shown in FIG. 3a and FIG. 3b, the protruding blocks are in a disk-like shape. In other embodiments, however, the protruding blocks can be in a rectangular shape, as shown in FIG. 4a and FIG. 4b, or other suitable shapes, such as triangles, squares, or other polygons.

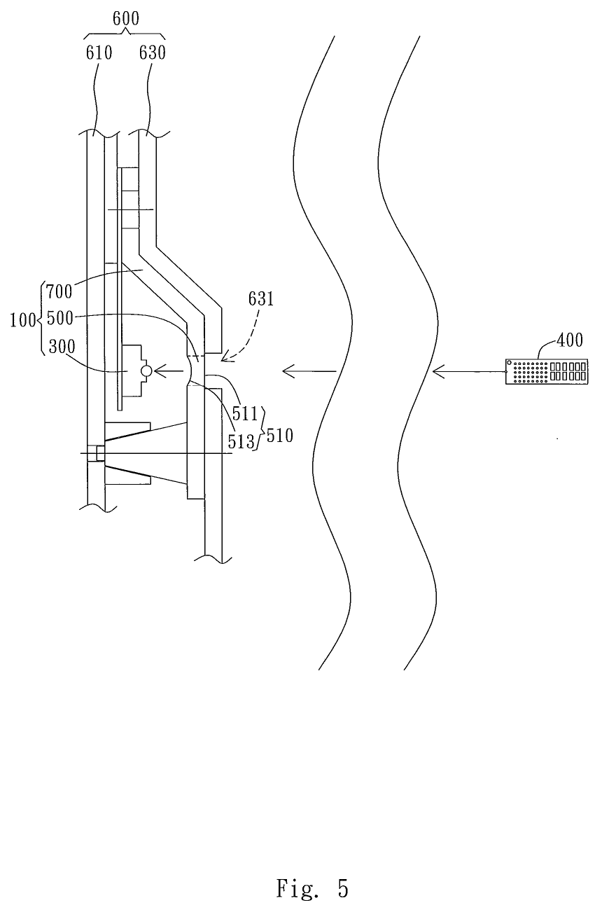

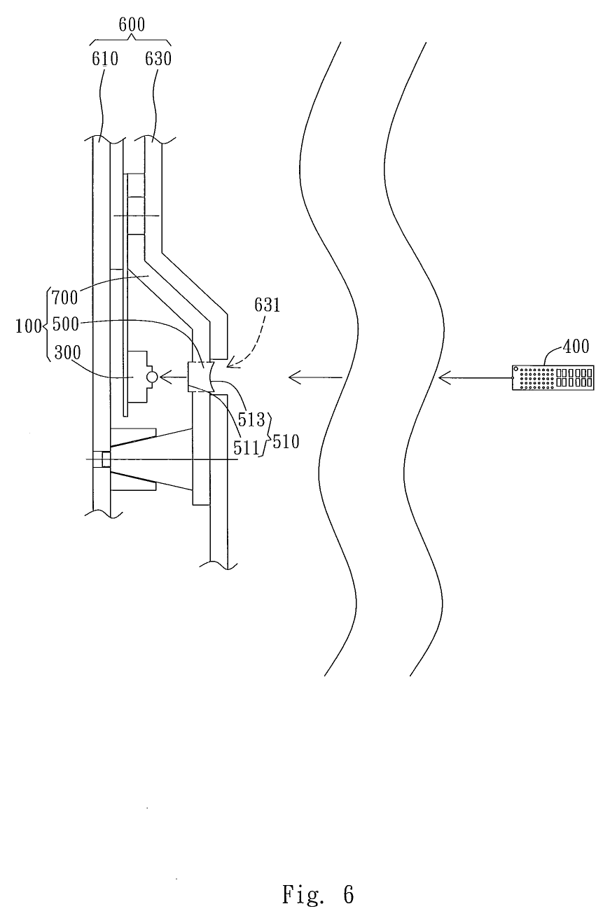

In other embodiments, the signal enhancer 500 are not necessarily to be disposed to penetrate through the support part 700 with two blocks protruding out of the support part 700 on two opposite sides. For example, as shown in FIG. 5, the signal enhancer 500 has a flat surface 511 coplanar with the support part 700, while the concave surface 513 is recessed into the signal enhancer 500 from the plane of the support part 700. Furthermore, the concave surface 513 is not necessarily disposed on a side of the signal enhancer 500 close to the signal receiver 300. For example, as shown in FIG. 6, the concave surface 513 is disposed on a side of the signal enhancer 500 away from the signal receiver 300.

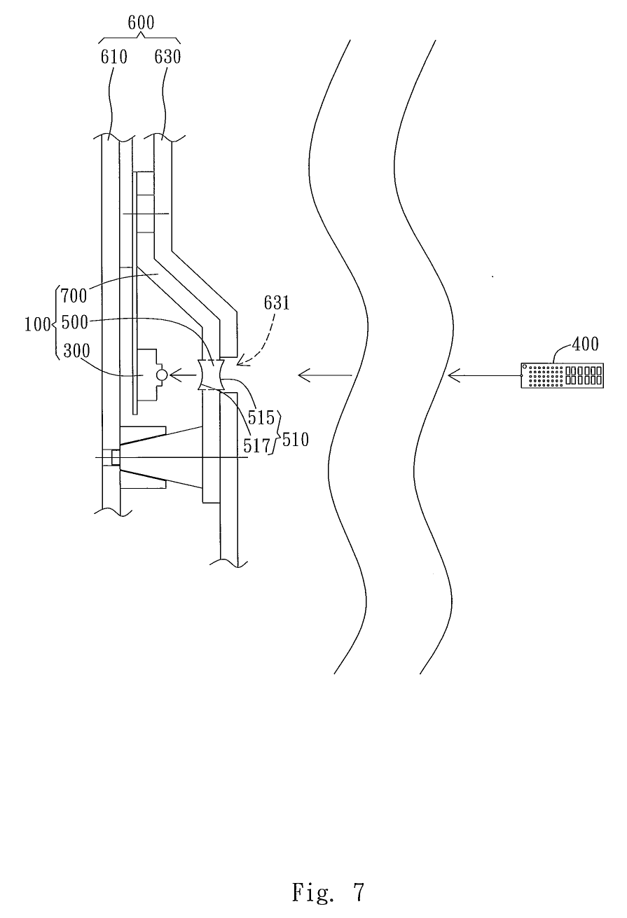

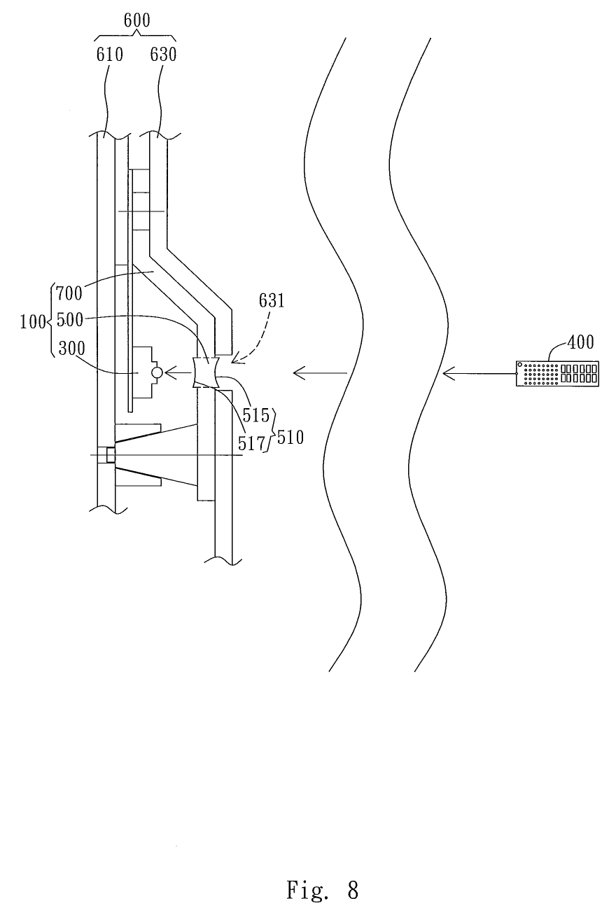

In another embodiment, as shown in FIG. 7, the signal enhancer 500 can be a biconcave lens. That is, the concave structure 510 includes a first concave surface 515 and a second concave surface 517 respectively disposed on opposite sides of the signal enhancer 500. As shown in FIG. 7, the first concave surface 515 and the second concave surface 517 have a same geometry shape and a same curvature. In another embodiment shown in FIG. 8, however, the first concave surface 515 and the second concave surface 517 have different curvatures. More particularly, as shown in FIG. 8, the first concave surface 515 and the second concave surface 517 have a same diameter, but the depth of the first concave surface 515 is larger than the depth of the second concave surface 517. In another embodiment, the first concave surface 515 and the second concave surface 517 may have different diameters and depths when the signal enhancer is in a trapezoid shape.

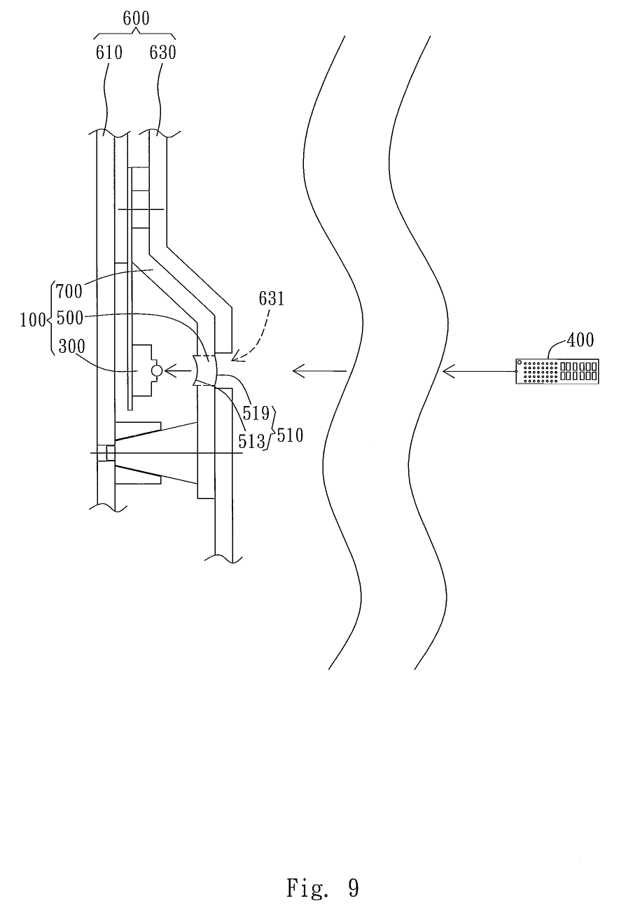

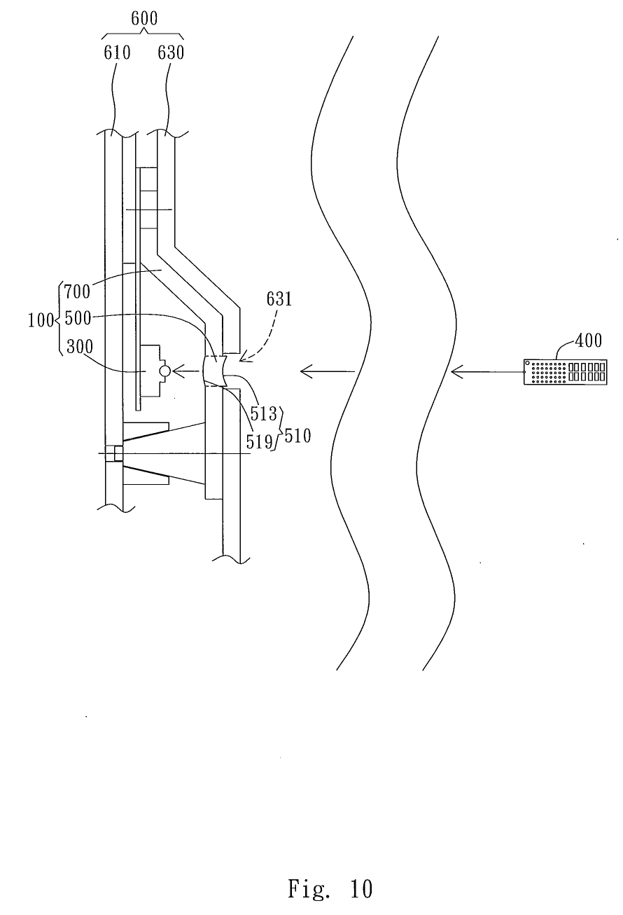

In other embodiments shown in FIG. 9 and FIG. 10, the signal enhancer 500 can be a convex-concave lens. That is, the concave structure 510 includes a concave surface 513 and a convex surface 519 respectively disposed on opposite sides of the signal enhancer 500. The concave surface 513 can be disposed on one side of the signal enhancer 500 close to the signal receiver 300, while the convex surface 519 is disposed on the other side of the signal enhancer 500 away from the signal receiver 300, as shown in FIG. 9. Alternatively, the concave surface 513 can be disposed on one side of the signal enhancer 500 away from the signal receiver 300, while the convex surface 519 is disposed on the other side of the signal enhancer 500 close to the signal receiver 300, as shown in FIG. 10. It is noted that the structure of the signal enhancer 500 is not limited to the embodiments illustrated above. The signal enhancer 500 can have any concave structure capable of enhancing the signal transmitted from the remote controller 400.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A receiver for use with a remote controller, the receiver comprising:
a signal receiver having a signal receiving end; and
a signal enhancer disposed in front of the signal receiver corresponding to the signal receiving end, wherein the signal enhancer is transparent to light and has a concave structure, and the signal receiver receives a signal through the signal enhancer.

2. The receiver of claim 1, wherein the concave structure includes a flat surface and a concave surface respectively disposed on opposite sides of the signal enhancer.

3. The receiver of claim 2, wherein the concave surface is disposed on a side of the signal enhancer close to the signal receiver.

4. The receiver of claim 2, wherein the concave surface is disposed on a side of the signal enhancer away from the signal receiver.

5. The receiver of claim 2, wherein the concave surface having a diameter is 1.2 to 5 times a depth of the concave surface.

6. The receiver of claim 1, wherein the concave structure includes a first concave surface and a second concave surface respectively disposed on opposite sides of the signal enhancer.

7. The receiver of claim 6, wherein the first concave surface and the second concave surface have a same curvature.

8. The receiver of claim 6, wherein the first concave surface and the second concave surface have different curvatures.

9. The receiver of claim 1, wherein the concave structure includes a concave surface and a convex surface respectively disposed on opposite sides of the signal enhancer.

10. The receiver of claim 9, wherein the concave surface is disposed on a side of the signal enhancer close to the signal receiver.

11. The receiver of claim 9, wherein the concave surface is disposed on a side of the signal enhancer away from the signal receiver.

12. The receiver of claim 1, further comprising a support part disposed on a same side of the signal receiver corresponding to the signal receiving end, wherein the signal enhancer is disposed on the support part.

13. The receiver of claim 1, wherein the remote controller is a remote control of a displayer.

14. A displayer, comprising:
a main body;
a signal receiver disposed on the main body, wherein the signal receiver has a signal receiving end; and
a support part disposed on an opposite side of the signal receiver corresponding to the main body, wherein the support part has a signal enhancer disposed in front of the signal receiver, the signal enhancer has a concave structure, and the signal receiver receives a signal transmitted from a remote controller through the signal enhancer.

15. The displayer of claim 14, further comprising a case covering the support part, wherein the case has a hole corresponding to the signal enhancer.

16. The displayer of claim 14, wherein the concave structure includes a flat surface and a concave surface respectively disposed on opposite sides of the signal enhancer.

17. The displayer of claim 16, wherein the concave surface is disposed on a side of the signal enhancer close to the signal receiver.

18. The displayer of claim 16, wherein the concave surface is disposed on a side of the signal enhancer away from the signal receiver.

19. The displayer of claim 16, wherein the concave surface having a diameter is 1.2 to 5 times a depth of the concave surface.

20. The displayer of claim 14, wherein the concave structure includes a first concave surface and a second concave surface respectively disposed on opposite sides of the signal enhancer.

21. The displayer of claim 20, wherein the first concave surface and the second concave surface have a same curvature.

22. The displayer of claim 20, wherein the first concave surface and the second concave surface have different curvatures.

23. The displayer of claim 14, wherein the concave structure includes a concave surface and a convex surface respectively disposed on opposite sides of the signal enhancer.

24. The displayer of claim 23, wherein the concave surface is disposed on a side of the signal enhancer close to the signal receiver.

25. The displayer of claim 23, wherein the concave surface is disposed on a side of the signal enhancer away from the signal receiver.
